(19) United States
(12) Patent Application Publication
(10) Pub. No.: US 2006/0144732 A1
(43) Pub. Date: Jul. 6, 2006

(54) Portable tool caddy

(76) Inventors: Pablo Kaplan, Herzelyia (IL); Richard Evans, Rishon Letzion (IL)

Correspondence Address: NATH & ASSOCIATES PLLC, 112 South West Street, Alexandria, VA, 22314, US

(21) Appl. No.: 11/322,343

(22) Filed: Jan. 3, 2006

(30) Foreign Application Priority Data
Jan. 3, 2005 (IL) 166101

(51) Int. Cl. A45C 11/26

(52) U.S. Cl. 206/349

(57) ABSTRACT

A tool caddy comprises a rigid bucket and a non-rigid tool organizer. The bucket comprises a bottom support portion, with vertical walls extending upwardly therefrom, forming front, back and side faces and defining a bucket interior, and an upper rim. The bucket further comprises at least two wheels and a retractable arm with a handgrip. The arm is extendable between a fully extended position and a fully retracted position and is attached to the bucket at the back face thereof. The bucket also has a sheath, integral with the back face of the bucket and giving rise to a receptacle adapted for slidingly receiving the arm. The tool organizer comprises exterior flaps adapted to cover outward faces of the bucket and interior flaps adapted to cover interior faces of the bucket. The exterior flaps are of sufficient length to substantially cover at least the entire front face of the bucket and is formed so as to not interfere with the operation of the wheels. The tool organizer also has contrivances, disposed on the flaps, for retaining various articles.

### FIELD OF THE INVENTION

This invention relates to receptacles used to transport tools, and especially to buckets adapted for that purpose.

### BACKGROUND OF THE INVENTION

It is a well accepted practice among tradesmen, especially those in various fields of construction, to use buckets or pails to transport tools to and around a jobsite. These buckets are often discarded five gallon containers which originally held spackle, paint, or the like. The use of these buckets is particularly convenient, since they are plentiful around jobsites and have no real cost, since they are destined to be discarded if not otherwise used. Their interiors are large enough to fit hand tools and many handheld power tools, and they are typically provided with a carrying handle for easy transport thereof.

One drawback of using such buckets for the above purpose is that smaller tools and pieces of hardware placed within may easily become misplaced among the larger tools, requiring time for the tradesman to search through the bucket for them when needed, resulting in lost time. It is therefore advantageous to provide retaining devices for use with a bucket for storing small tools and hardware.

Additionally, these buckets are often transported by use of an external trolley or cart. These carts are typically in the form of a hand truck, or other multipurpose conveyance, which are usually cumbersome. It is therefore further advantageous to provide a cart for a bucket which is easily used.

There are known in the art several tool organizers adapted for use with a bucket to organize smaller tools therein. U.S. Pat. No. 6,315,310 discloses a portable vessel receptacle which includes a combination of a frame, preferably a wheeled frame supporting a bucket container or vessel. The vessel is a generally cylindrical open top receiver having a lifting handle, and optionally being provided with a fabric tool carrying cowl. The lower portion of the bucket is releasably secured to the frame by means of a positionally adjustable clamping pad along with a pair of accurately spaced radially inwardly extending gussets which are secured to the frame, thereby facilitating an additional lifting mechanism for the entire assembly. For added stability, the top portion of the bucket or vessel is reliably releasably secured to the frame by means of a “J” hook or claw which is adjustably positioned on an upright or vertical handle, with the claw engaging and restraining the vessel at a point adjacent the upper edge thereof, preferably being engaged with the handle receiving projections on the outer surface of the bucket. Optionally, the assembly may be provided with a shroud for carrying or holding tools, such as hand tools or of the like with the shroud being configured to fit within the cylindrical vessel. The vessel also provides a receptacle for debris as well as for articles useful for homeowners as well as tradesmen for home projects and similar applications.

U.S. Pat. No. 5,174,447 discloses a tool carrier for use with open top containers formed initially as a rectangular blank having side edges sewn together to form a cylinder. The cylinder is inserted within the open top area of the container and oriented to be draped on both interior and exterior side walls of the container. Thus, the tool carrier forms inner and outer sheaths upon which a plurality of tools can be carried. The tools are carried on the inner and outer sheaths by means of pockets and loops through which the tools or a portion thereof are to pass.

U.S. Pat. No. 4,993,551 discloses a tool organizer and storage device to interfit over the upper rim of a five gallon bucket. The device includes a tubular cloth panel which drapes and conforms over the inside and outside surfaces of the bucket with inner pockets sewn on the panel to drape on the inside of the bucket and outer pockets sewn on the panel to drape on the outside surface of the bucket with slots cut lengthwise from an end of the cloth panel of sufficient length to allow the panel to drape downwardly around the handle ends of the bucket on the outside surface with ties between the edges of the slots to fix the device under the handle ends.

U.S. Pat. No. 6,454,281 discloses a utility tool cart that is especially designed for carrying tools and equipment around work environments such as construction sites. The utility tool cart is a hand cart that is particularly adapted to carry equipment over long distances and/or difficult terrain. The utility tool cart contains a pair of wheels near the bottom thereof, a first support unit for holding a first tool container, a second support unit for holding a second tool container and a telescoping shaft having a hand grip.

U.S. Pat. No. 5,806,867 discloses a wheeled trolley having a resilient engaging wall for retaining a standard wheeled trolley having a resilient engaging wall for retaining a standard sized bucket containing a load. The trolley includes a set of wheels to permit easy movement over a surface. The bottom of the bucket is disposed between the wheels to provide a low center of gravity to ensure stability. The bucket is retained by a resilient engaging wall such that the trolley is lifted along with the bucket for moving up and down stairs. An adapter is located on the trolley for interchangeably receiving a handle. The handle may alternatively serve as a handle, or an extension of a handle for a tool associated with the use of the trolley.

It is an object of the present invention to provide a tool carrying bucket fitted with a pouched organizer and integrated with wheels and a maneuvering arm.

### SUMMARY OF THE INVENTION

According to the present invention, there is provided a tool caddy, comprising a rigid bucket and a non-rigid tool organizer. The bucket comprises a bottom support portion, vertical side walls extending upwardly therefrom and defining a bucket interior, and an upper rim. It further comprises at least two wheels joined and attached to the bucket by an axle extending therebetween, a retractable arm with a handgrip, and a sheath, integrated externally to a back face of the bucket, adapted for receiving the arm. The retractable arm is extendable between a fully extended position and a fully retracted position.

According to an embodiment of the present invention, the tool caddy further comprises a carrying handle. According to one particular design, the carrying handle is made of a flexible material and may be length-adjustable to facilitate carrying it at a hand-carrying position or a shoulder-carrying position. Typically, the carrying handle is detachably connectable to attachments formed in the upper rim of the bucket, adapted to receive therein the handle, and, by a different application, the carrying handle may be detachably connectable to attachments integrated in the tool organizer to facilitate carrying it independent of the bucket.

The tool organizer comprises wings for covering outward and interior faces of the bucket. Disposed upon the wings are contrivances for retaining various tool and articles, including some hooks, loops, pockets, and pouches. The various contrivances are disposed on surfaces of the tool organizer adapted to cover the entire outer perimeter including the back face, and the interior of the bucket. The tool organizer further comprises openings adapted to allow passage therethrough of the arm and the handle of the bucket. The tool organizer is of sufficient length to substantially cover at least the entire front face of the bucket and is formed so as to not interfere with the operation of the wheels.

According to another arrangement of the present invention, the at least two wheels are joined and attached to the bucket by a common axle and, by a particular arrangement, said axle extends through a lower end of the retractable arm.

The tool caddy may further comprise a cover adapted to protect the contents retained in the tool caddy, said cover may extend over the opening of the bucket in which case it is likely to be fitted with a zipper or other closing arrangements such as hook and pile fastener (Velcro™). Alternatively, the cover may extend over the entire bucket.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIGS. 1A and 1B are perspective views of a tool caddy according to one aspect of the present invention;

FIG. 2 is perspective view of a bucket of the present invention;

FIG. 3 is a side view of the bucket shown in FIG. 2;

FIG. 4 is perspective view of a tool caddy according to another embodiment of the present invention having a cover.

FIGS. 5A and 5B are side and perspective views, respectively, of the bucket of the present invention according to further embodiment;

FIG. 6 is a perspective view of the bucket of the present invention according to a still further embodiment;

FIG. 7 is a side view of the bucket of the present invention according to a still further embodiment;

FIG. 8 is a perspective cross-sectional view taken along line III-III in FIG. 1A, showing an additional embodiment;

FIG. 9 is a perspective cross-sectional view taken along line III-III in FIG. 1A, showing another embodiment, wherein a bottom surface of a tool organizer covers the bottom surface of the bucket;

FIGS. 10A through 10E are perspective views showing embodiments regarding placement of the axle (FIGS. 10B and 10C do not show the axle, FIG. 10E does not show the wheels); and

FIGS. 11A through 11C are perspective views are the bucket according to several embodiments (all shown without wheels or arm).

### DETAILED DESCRIPTION OF THE INVENTION

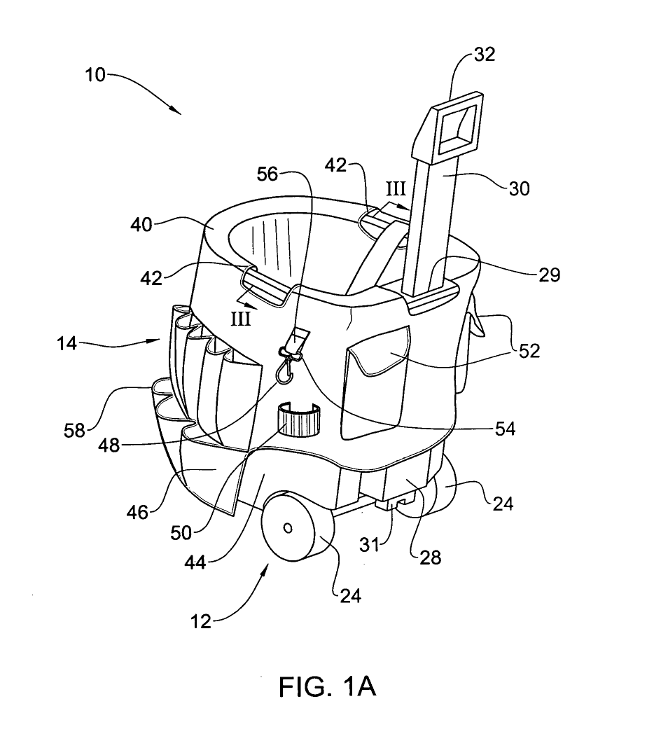

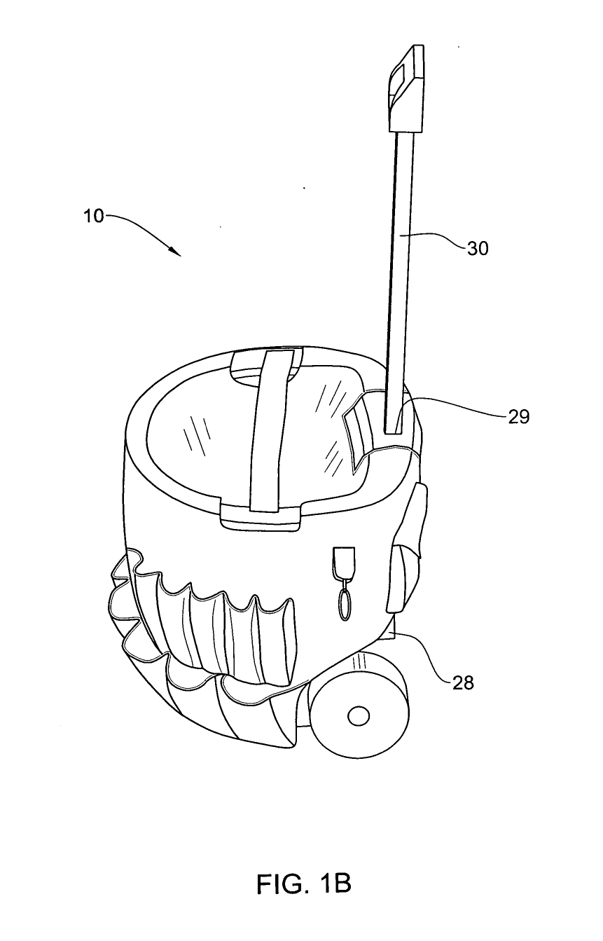

FIG. 1A shows a tool caddy, generally designated as 10. The receptacle comprises a rigid bucket 12, and a non-rigid tool organizer 14. The bucket 12 is typically a five gallon container (though any size is suitable) made from a high density polymer such as plastic.

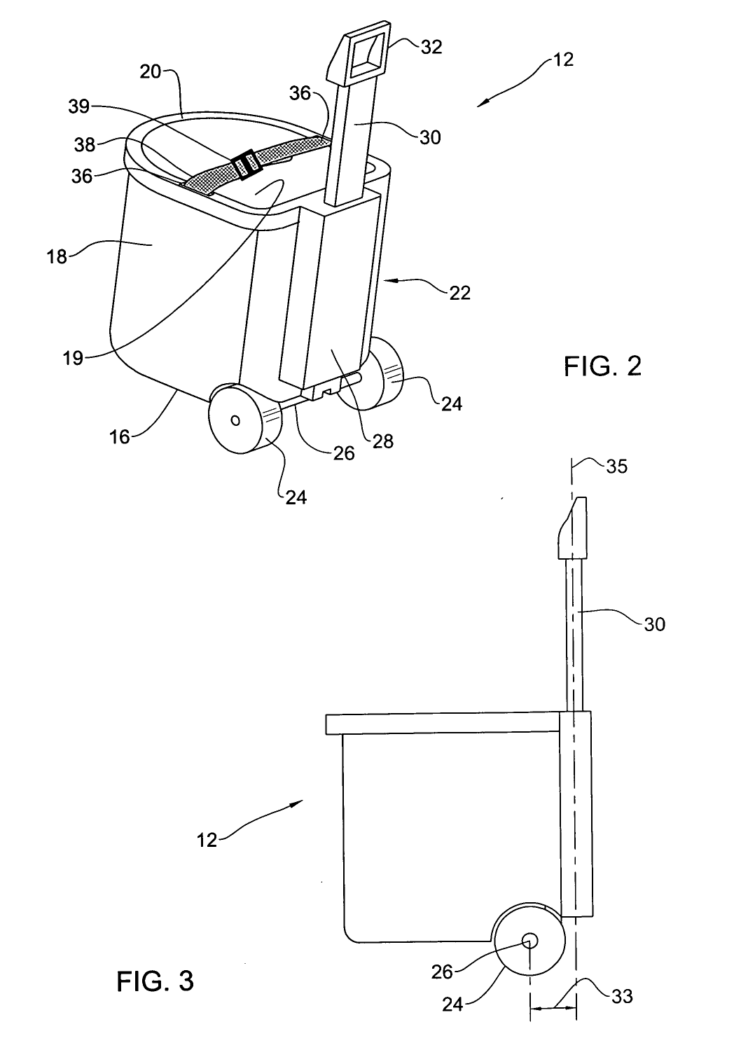

As seen in FIG. 2, the bucket 12 comprises a bottom support wall 16, vertical sidewalls 18 extending upwardly therefrom and defining a bucket interior 19, and an upper rim 20. The bucket 12 further comprises, at a back face 22, two wheels 24 attached by a common axle 26 extending therebetween and passing through axle supports formed in the bucket 12. Extending upwardly along the height of the bucket 12 on the back face 22 thereof and integrated therein is a sheath 28. The sheath 28 is a longitudinally extending wall giving rise to an aperture 29 of substantially constant cross-section and which follows a straight path, extending upright and parallel to a longitudinal axis of the bucket 12.

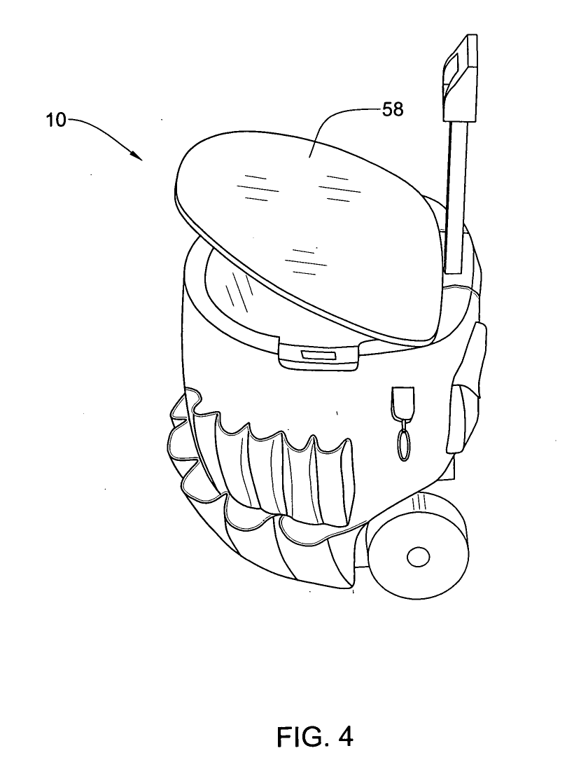

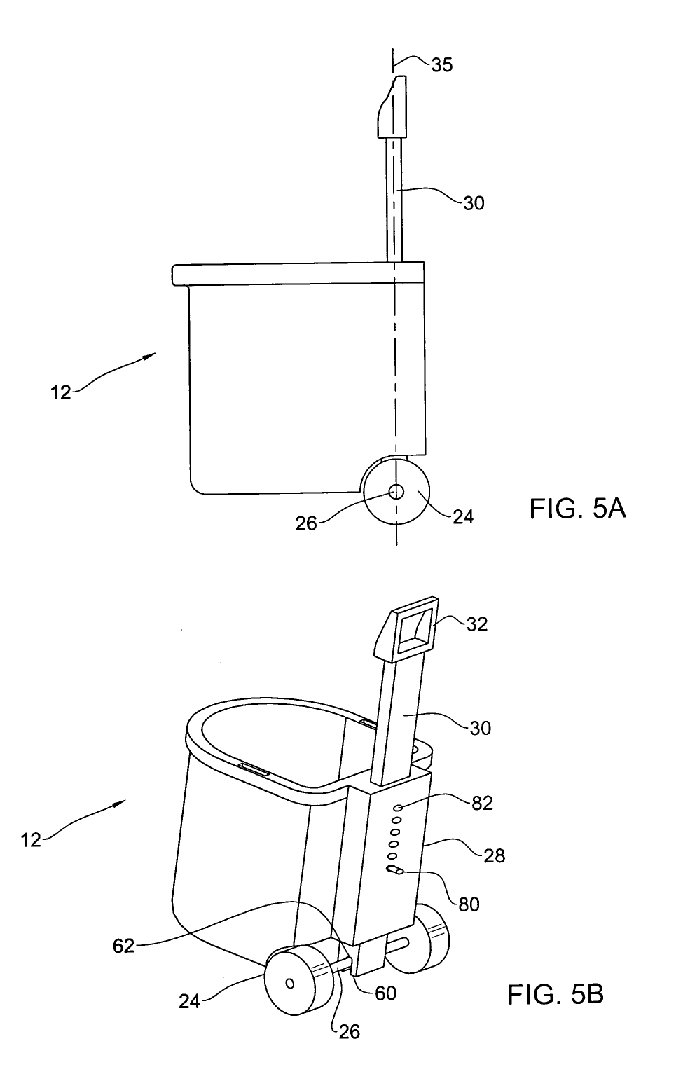

Received within aperture 29 formed by the sheath 28 is a retractable arm 30 having, at its upper end, a handgrip 32. The retractable arm 30 is extendable between a fully retracted position (as in FIG. 1A), in which the bottom end 31 thereof is disposed at or near the bottom end of the sheath 28, and a fully extended position (as in FIG. 1B), in which the bottom end thereof is disposed at or near the top of the sheath. The retractable arm 30 may be arrested in one or more intermediate positions between the fully retracted and fully extended positions. For example, there may be a snap-arresting arrangement, or a spring-loaded pin 80 extending from the arm 30, and a series of apertures 82 disposed in the sheath 28 adapted to receive the pin 80 at several arresting positions and arrest thereby the arm 30 (as in FIG. 5B, the pin 80 shown received within an aperture 82).

As seen most clearly in FIG. 3, the sheath 28 is coincident with plane 35 which lies parallel to the axle 26. The axle 26 is disposed away from the plane 35 toward the front 34 of the bucket 12. In operation, the user pulls on the arm 30 to lift the bucket 12, which may be loaded with heavy tools, thereby tilting the tool caddy to allow for easy transport on its wheels. By locating the sheath 28 thusly, there is provided a larger moment arm distance 33, which leads to a greater mechanical advantage in lifting the bucket. This arrangement permits easy tilting of the bucket by using the arm 30.

The rim 20 comprises. two apertures 36 adapted to receive a handle strap 38. The handle strap is preferable a fabric band somewhat longer than the diameter of the bucket interior 19. This provides slack for the handle strap 38 which permits comfortable carrying of the bucket 12, even when laden with tools. The handle strap 38 may be detachable from the bucket, to permit placement therein of large or numerous articles. The handle strap 38 may comprise a buckle 39 in order to facilitate selective adjustment of the strap handle length.

Reverting now to FIG. 1A, the tool organizer 14 is shown in its operational position draped on the bucket 12. The tool organizer is preferably made from a sturdy material, such as canvas or nylon. The edges thereof may be bounded with fabric which is of a different color that the rest of the tool organizer. It comprises a rim receiving portion 40 which has three openings 42 which, when the tool organizer is in its operational position, are aligned with the apertures 36 and the top of the sheath 28. This arrangement allows easy passage therethrough of the arm 30 and the handle 38.

The tool organizer 14 is of sufficient height so as to substantially cover the front 34 of the bucket 12. In this way, the surface area which can be utilized for storage of tools is maximized. It is contoured in an area 44 that corresponds, when draped on the bucket 12, to the wheels 24, in order to prevent interference of the tool organizer 14 therewith during wheeled transport of the tool caddy, and allowing the tool organizer to cover the back face 22 of the bucket. The tool organizer 14 at least partially covers the bucket interior 19, while not obstructing the majority thereof.

The tool organizer 14 is provided with various contrivances designed to hold tools having a range of different shapes. These contrivances include, but are not limited to, pockets 46, hooks 48, and loops 50. In addition, some or all of the pockets 46 may comprise a flap 52 adapted to close them. The pockets are formed by attaching a pocket forming strip 54 along a portion of the tool organizer. The pockets 46 and respective flaps 52 may comprise cooperating fastening means such as a hook and loop arrangement or snaps for selectively retaining the flaps 52 in a closed position. Each hook 48, which may be a swivel snap or slide bolt hook, is secured to a ring 54 which is in turn secured to the tool organizer 14 by a loop of material 56 which is sewn thereto.

Owing to the construction of the tool organizer 14 as described above, especially in reference to the openings 42 and the contour in the area 44 corresponding to the wheels, contrivances, as described above, may be placed around the entire bucket 12, including along the back face 22 without interfering with the use of the retractable arm 30 or the wheels 24.

As seen in FIG. 4, the tool organizer 14 may comprise an integrated top cover 58. The cover 58 is preferably made from the same material as the tool organizer 14, and may be designed with the same color pattern. It is of sufficient size so as to protect to tools from rain without having to remove same from their respective storage locations, be they one of the contrivances descried above or the bucket interior 19. The tool organizer 14 may optionally be provided with a pouch, adapted to store the cover 58 when not in use.

Various configurations of the arm 30 are possible. According to one embodiment, shown in FIGS. 5A and 5B, the plane 35 coincident with the arm 30 intersects the axle 26. The arm therefore is provided with a straight slot 60 which is adapted to receive therein the axle 26. The width of the slot 60 should be at least slightly larger than the diameter of the axle 26, in order to facilitate easy receipt therein. The height of the slot is sufficient so that at least a minimal clearance is provided between the axle 26 and the top of the slot 62 when the arm 30 is in its fully retracted position.

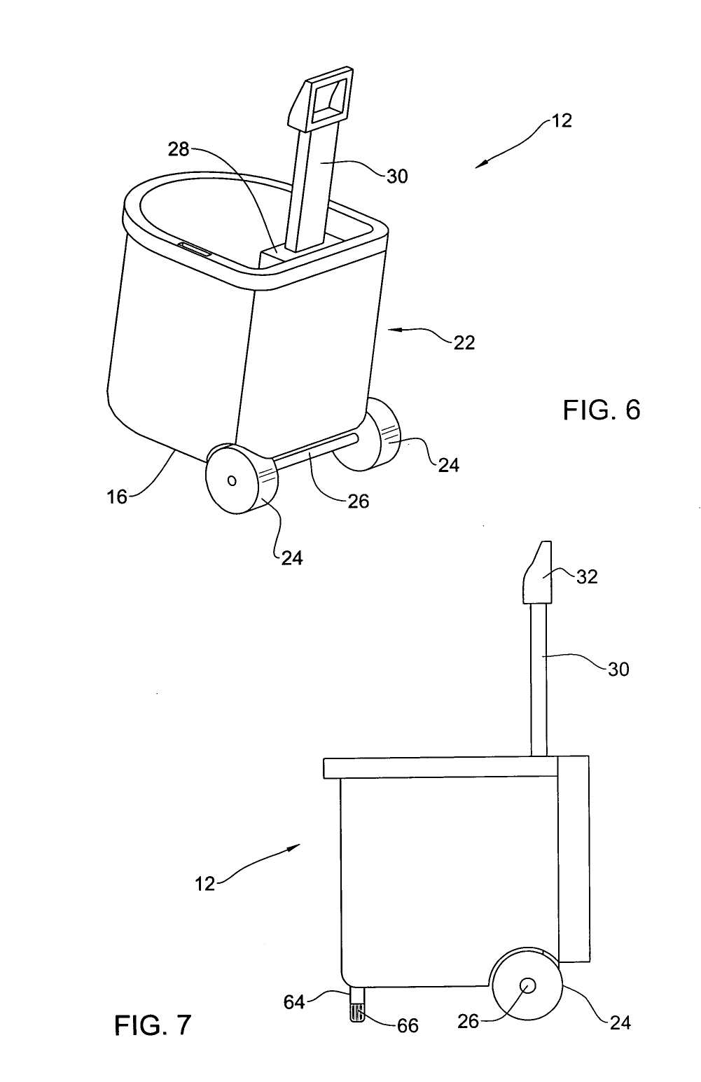

Another embodiment is shown in FIG. 6, in which the sheath 28 in integrated into the interior of the bucket 12, opposite the back face 22. This embodiments permits a more compact design of the bucket 12.

According to a further embodiment, as shown in FIG. 7, there is provided 15 at least one support foot 64, disposed on the bottom of the bucket 12, opposite the wheels 24. The foot may be formed as an integrated part of the bucket, or may be formed separately and attached thereto. If formed separately, the support foot 64 may be made from a viscoelastic material to prevent sliding. Alternatively, the support foot 64 may optionally comprise a pad 66, made from a viscoelastic material.

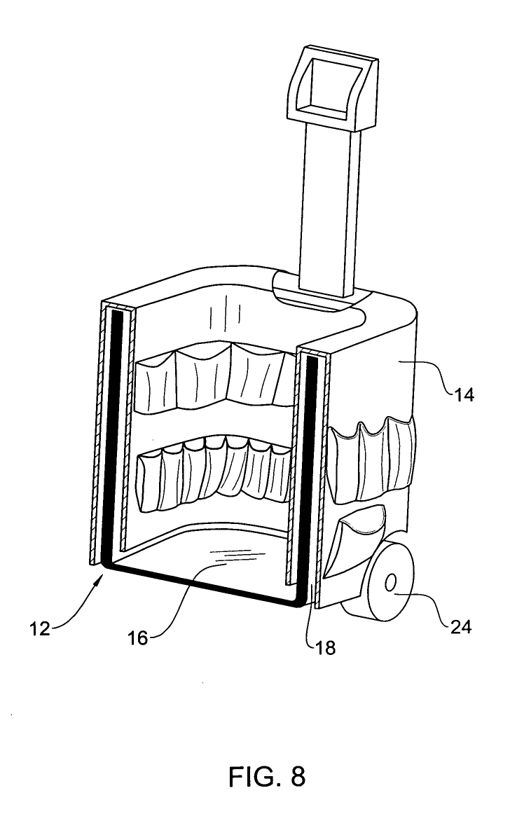

According to a still further embodiment of the present invention, the tool carrier 14 is adapted to fully cover the interior walls of the bucket 12 (FIG. 8). The portion of the tool organizer 14 adapted to cover in interior of the bucket 12 is of sufficient length to cover the entire vertical sidewalls 18.

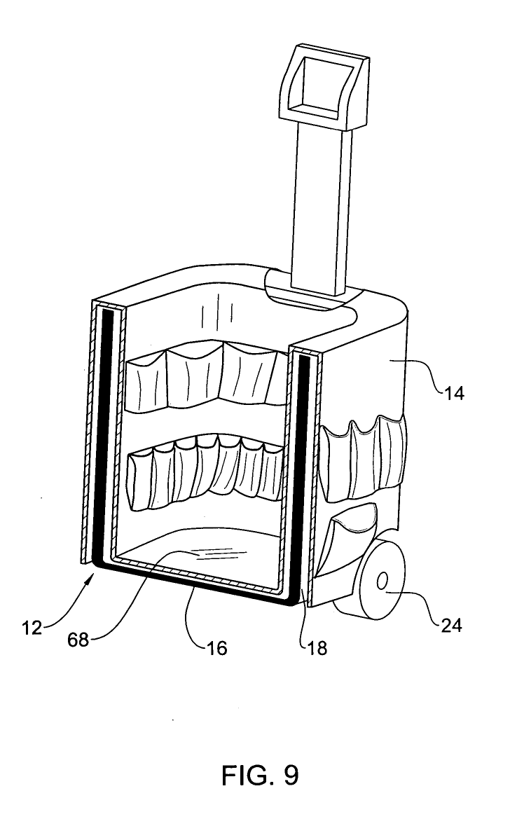

As shown in FIG. 9, there is provided an interior bottom surface 68 for the tool organizer 14 according to a still further embodiment of the present invention. The height of the tool organizer is sufficient to allow the bottom surface 68 to rest on the bottom support wall 16 of the bucket 12. This limits accidental puncture of the bottom surface 68 by sharp or heavy objects placed thereupon.

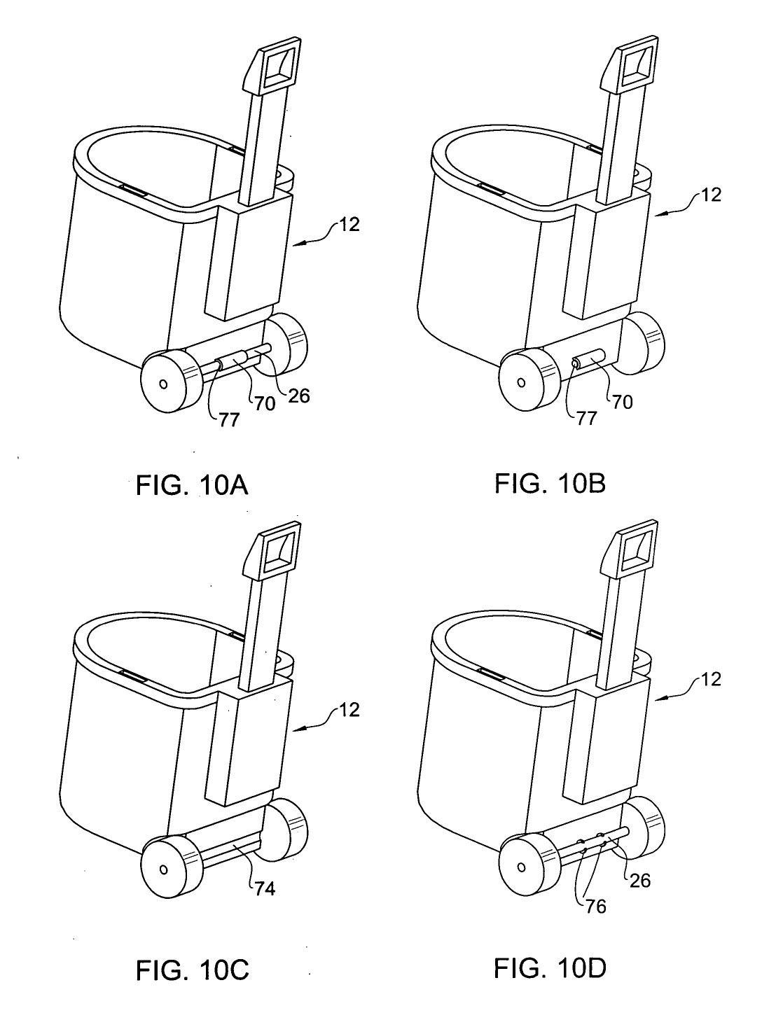

According to an additional embodiment, the axle 26 is retained within the back wall. This may be accomplished by a protrusion 70 formed as part of the back face 22 having an aperture 72 therethrough adapted to receive the axle 26, (as in FIG. 10A and FIG. 10B) or through the use of a groove 74 integrated into the back face (as in FIG. 10C). Alternatively, there may be provided grasping members 76, such as clips, incorporated into the back face 22, said grasping members being adapted to snappably receive the axle 26 (as in FIG. 10D). The bucket may be adapted to receive the axle through its interior, via apertures 78 disposed in its side (as in FIG. 10E).

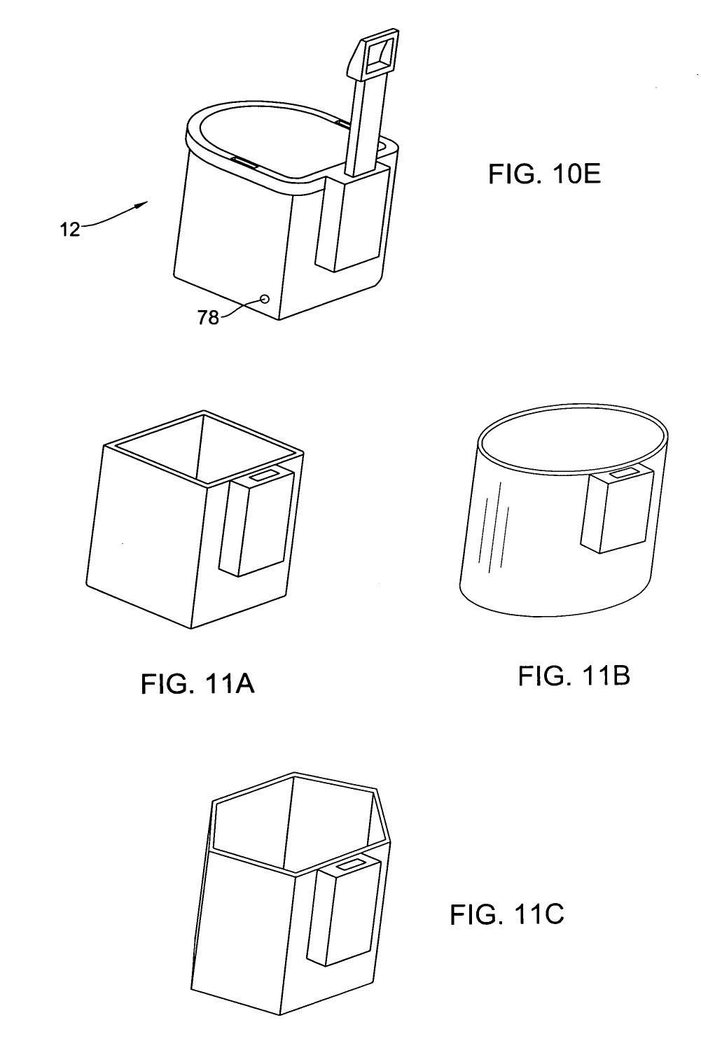

The shape of the bucket is not limited to the ones illustrated in the figures henceforth. Other embodiments of the shape of the bucket, such as a square (as in FIG. 11A), a circle (as in FIG. 11B), and a hexagon (as in FIG. 11C) are possible.

It will be appreciated by persons skilled in the art that the present invention is not limited by what has been particularly shown by the exemplary embodiment described hereinabove. Thus, the tool organizer and bucket can be embodied by a variety of aspects within the scope of the invention, mutatis mutandis.

1. A tool caddy, comprising a rigid bucket and a non-rigid tool organizer, the bucket comprising:
(a) a bottom support portion, with vertical walls extending upwardly therefrom, forming front, back and side faces and defining a bucket interior, and an upper rim;
(b) at least two wheels;
(c) a retractable arm with a handgrip, the arm extendable between a fully extended position and a fully retracted position and attached to the bucket at the back face thereof;
(d) a sheath, integral with the back face of the bucket and giving rise to a receptacle adapted for slidingly receiving the arm;
the tool organizer comprising:
(e) exterior flaps adapted to cover outward faces of the bucket and interior flaps adapted to cover interior faces of the bucket, said exterior flaps being of sufficient length to substantially cover at least the entire front face of the bucket and is formed so as to not interfere with the operation of the wheels; and
(f) contrivances for retaining various articles, said contrivances being disposed on the flaps.

2. A tool caddy according to claim 1, further comprising a non-rigid handle.

3. A tool caddy according to claim 2, wherein the handle is length-adjustable.

4. A tool caddy according to claim 2, further comprising an arrangement for detachably connecting the handle to the upper rim of the bucket.

5. A tool caddy according to claim 2, wherein the tool organizer further comprises at least two openings adapted to allow passage therethrough of the handle.

6. A tool caddy according to claim 1, wherein at least some of the at least two wheels are joined to each other and attached to the bucket by a common axle extending therebetween.

7. A tool caddy according to claim 1, wherein the tool organizer further comprises an opening sized to allow passage therethrough of the arm.

8. A tool caddy according to claim 1, wherein the contrivances include at least one from the set comprising hooks, loops, pockets, and pouches.

9. A tool caddy according to claim 1, wherein the sheath is integral external to the bucket on a back face thereof and coincident with a plane, the axle disposed away from the plane in a direction toward the front face.

10. A tool caddy according to claim 1, wherein the sheath is located in a plane coincident with the axis.

11. A tool caddy according to claim 10, wherein the arm comprises a slot adapted to receive the axle when the arm is in the fully retracted position.

12. A tool caddy according to claim 1, wherein the sheath is integral to an interior wall of the bucket opposite a back face and coincident with a plane, the plane being disposed between the center of gravity of the bucket and the axle.

13. A tool caddy according to claim 1, further comprising a cover adapted to protect the contents retained in the tool caddy.

14. A tool caddy according to claim 13, wherein the cover is adapted to cover the bucket interior.

15. A tool caddy according to claim 13, wherein the cover is adapted to cover the entire tool caddy.

16. A tool caddy according to claim 13, wherein the cover and the tool organizer comprise complementary closing arrangements.

17. A tool caddy according to claim 13, wherein the cover is integral to the tool organizer.

18. A tool caddy according to claim 13, wherein the tool organizer comprises a pouch adapted to store the cover.

19. A tool caddy according to claim 1, further comprising at least one support foot integral to the bucket for supporting to bucket in an essentially horizontal position.

20. A tool caddy according to claim 19, wherein the support foot further comprises a pad.

21. A tool caddy according to claim 1, wherein the tool organizer is adapted to fully cover interior vertical side walls.

22. A tool caddy according to claim 21, wherein the tool organizer further comprises a bottom surface.

23. A tool caddy according to claim 22, wherein the bottom surface rests directly on the bottom support portion of the bucket.
